(19) United States
(12) Patent Application Publication
(10) Pub. No.: US 2007/0232132 A1
(43) Pub. Date: Oct. 4, 2007

(54) Stacked connectors for high density external cable connections

(76) Inventors: Yun Ling, Portland, OR (US); Daniel Tong, Beaverton, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/393,169

(22) Filed: Mar. 29, 2006

(51) Int. Cl. H01R 13/66

(52) U.S. Cl. 439/541.5

(57) ABSTRACT

A method and apparatus to couple one unified display interface (UDI) connector with another connector, such that the UDI connector is coupled between the other connector and a circuit board, such as a motherboard or add-in card. The UDI connector may be coupled to other I/O connectors, for example a VGA connector. The UDI connector may be coupled to one or more UDI connectors. The coupled connectors may have the same molded connector assembly and may have an integrated metal shell. On the source or host-end, two or more UDI plug connectors are made on the same cable over-mold to place the plug connectors closely to each other, minimizing the height of the coupled connectors. The cable exiting the multi-plug over-mold may be separated and attached to individual UDI plug connectors, connecting multiple monitors. Both ends of the cable may have multi-plugs in the same over-mold at each end. Such a cable may be used to support additional UDI lanes for higher bandwidths.

### TECHNICAL FIELD

This invention relates to the field of connector assemblies and, in particular, to Unified Display Interface (UDI) connectors.

### BACKGROUND

As the trend of small form factor (with more functionality) continues, placing all the necessary external input-output (I/O) connectors within an increasingly smaller area becomes more challenging. A common solution to increase the connector density has been to stack I/O connectors above each other. FIG. 1 illustrates one example of I/O connectors on a motherboard I/O back-panel. All the I/O connectors in this example are stacked to achieve the required functionality and connector density. Stacked connectors exist in a variety of combinations, for example, universal serial bus (USB) on USB, i.Link™ or FireWire™ (IEEE 1394 standard, IEEE std. 1394-1995, 1394a-2000, and 1394b-2002, published in 1995, 2000, and 2002, respectively) on USB, registered jack-45 (RJ-45) on USB, video graphics array (VGA) on digital visual interface (DVI). In FIG. 1, motherboard 101 includes four stacked USB receptacle connectors 102, two stacked Ethernet receptacle connectors 103, a super-video (S-Video) receptacle connector 104, multiple RCA receptacle connectors 105 stacked over the S-Video receptacle connector 104, a DVI receptacle connector 105, a VGA receptacle connector 106 stacked on the DVI receptacle connector 105, and multiple audio receptacle connectors 108 for plugging in speakers and microphones, and the like.

One conventional design of stacked I/O connectors includes an RJ connector and two stacked USB connectors stacked on the RJ connectors, the RJ connector having a first housing, and the two USB connectors having a common second housing. The first and second housings are then connected together by a tenon-mortise joint (e.g., dovetailed joint). An outer shield encloses both the RJ connector and the two USB connectors. The USB and RJ connectors can also reside in a single housing. (U.S. Pat. No. 6,155,872)

Another conventional design includes a stacked local area network (LAN) connector, which includes a stacked USB component and a modular jack component secured in respective portions of a main housing. The USB components are stacked underneath the modular jack. (U.S. Pat. No. 6,162,089 & U.S. Pat. No. 6,174,198).

UDI (Unified Display Interfaces) is an industry initiative to enable the next generation display technologies. UDI will introduce a new receptacle connector for computing devices, such as a personal computer (PC). This receptacle connector is to be connected to monitors, digital televisions (DTVs), and/or other displays via a cable. When introducing new interfaces, such as UDI, there may be a certain period of coexistence between the new interface and already existing interfaces, such as VGA. Because there are already many standard receptacle connectors on a circuit board (e.g., motherboard or add-in card), which occupy a significant amount of space on the circuit board already, adding new connector receptacles introduces some problems. One problem is the lack of real estate on the circuit board (or add-in card bracket). Stacking connectors on top of one another may solve the lack or real estate problem; other problems may arise, such as possible cross talk between connectors, and signal integrity problems introduced by the added distance from the connectors to the circuit board. In particular, in high-speed data transfer applications using such connectors as a high-definition multi-media interface (HDMI), digital visual interface (DVI), and UDI connectors, the placement of a receptacle connector farther away from the circuit board can cause loss in signal integrity.

### BRIEF DESCRIPTION OF THE DRAWINGS

The present invention is illustrated by way of example, and not by way of limitation, in the figures of the accompanying drawings.

FIG. 1 illustrates a conventional circuit board including various stacked connectors.

FIG. 2A illustrates a top-side view of one embodiment of stacked VGA-UDI receptacle connectors on a circuit board.

FIG. 2B illustrates a bottom-side view of the embodiment of FIG. 2A.

FIG. 3 illustrates a top-side view of the embodiment of FIG. 2A and a VGA cable and a UDI cable.

FIG. 4A illustrates a top-side view of one embodiment of stacked UDI-UDI receptacle connectors.

FIG. 4B illustrates a bottom-side view of the embodiment of FIG. 4A.

FIG. 5A illustrates a side view of one embodiment of a dual UDI plug connector and cable.

FIG. 5B illustrates a front-side view of the embodiment of FIG. 5A.

FIG. 6A illustrates one embodiment of a dual plug connector having two cables to couple to two monitors.

FIG. 6B illustrates one embodiment of a dual plug connector having one cable to couple to a double-lane-width single monitor.

FIG. 7 illustrates one embodiment of a bracket of an add-in card, including stacked UDI-UDI receptacle connectors.

FIG. 8 illustrates one embodiment of an adapter having dual UDI plug connectors at one end and a receptacle connector at the other.

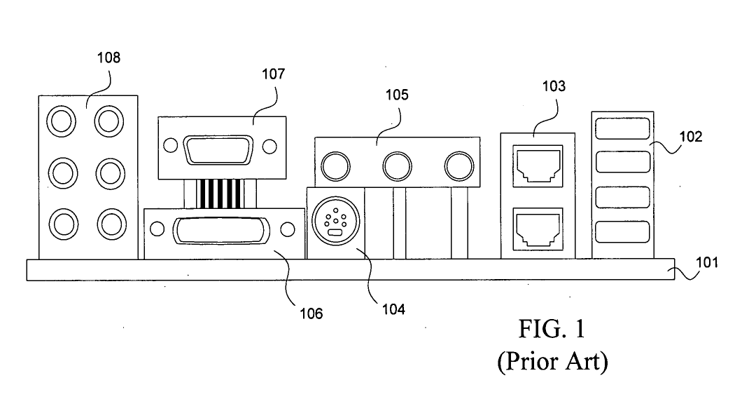

### DETAILED DESCRIPTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the spirit and scope of the present invention.

Embodiments of the present invention include various operations, which will be described below. As used herein, the term “coupled to” may mean coupled directly or indirectly through one or more intervening components.

Described herein are embodiments of a method and apparatus to couple one UDI connector to another connector, such that the UDI connector is coupled between the other connector and a circuit board, such as a motherboard or add-in card. The UDI connectors may be an display interface between a personal computer and a monitor, a personal computer and other peripherals, such as a TV, DTV, a personal data assistant (PDA), multi-media handhelds, digital cameras, digital camcorders, DVD players, digital video recorders, video cassette recorder (VCRs), or consumer electronic electronics known by those of ordinary skill in the art. The UDI connector may be coupled to other I/O connectors, for example a VGA connector. The UDI connector may be coupled to one or more UDI connectors. The coupled connector may have the same molded connector assembly (e.g., molding, fitting, or over-mold) and may have an integrated metal shell.

On the source or host-end, two or more UDI plug connectors may be made on the same cable over-mold to place the plug connectors closely to each other, minimizing the height of the coupled plug connectors. The cable exiting the multi-plug over-mold may be separated and attached to individual UDI plug connectors, connecting multiple monitors. Both ends of the cable may have multi-plugs in the same over-mold at each end. Such a cable may be used to support additional UDI lanes for higher bandwidth.

As previously mentioned, UDI is an industry initiative to enable the next generation display technologies, with the product intercept in 2007. UDI will introduce a new receptacle connector, and corresponding plug connector, for computing devices, such as a personal computer (PC). This receptacle connector is to be connected to monitors, and/or digital televisions (DTVs), and other known destinations, via a cable. The cable may include the UDI plug connector on one end to connect with the UDI receptacle connector, and at the other end, the cable may include another UDI connector, or alternatively, another type of plug connector, such as HDMI or DVI connector, to couple to various display devices. In another embodiment, the UDI plug connector may be part of a UDI adapter instead of a cable. The UDI adapter may include the UDI plug connector to be connected to the UDI receptacle connector at one end, and at the other end, another receptacle connector of another type, such as those described herein (e.g., USB, VGA, i.Link™ or FireWire™, RJ-45, DVI, HDMI, or S-Video) or other known receptacle connectors known by those of ordinary skill in the art.

In one embodiment, the UDI connector may be molded in the same connector body as the VGA. The metal shell for electromagnetic interference (EMI) containment may be integrated together for such a connector. Integrating the multiple receptacle connectors with an integrated metal shell may be used to reduce or contain EMI.

In another embodiment, the UDI connector may be placed at the bottom of the coupled connector to minimize the contact electrical length between the UDI connector and the circuit board, optimizing the high-speed performance of the UDI connector. Placement of UDI connector on the circuit board may affect the electrical performance of the interface. It is well known that the longer the signal path, the worse the performance can be. Thus, by placing the UDI between the circuit board and the other receptacle connector, the UDI signal path is decreased, improving the performance (e.g., signal integrity) of the UDI. For example, UDI involves faster transmissions than VGA, and by coupling the VGA to the UDI, such that the UDI is coupled between the VGA and the circuit board (e.g., UDI is the closest to the circuit board), signal speed, and signal integrity of the UDI is optimized.

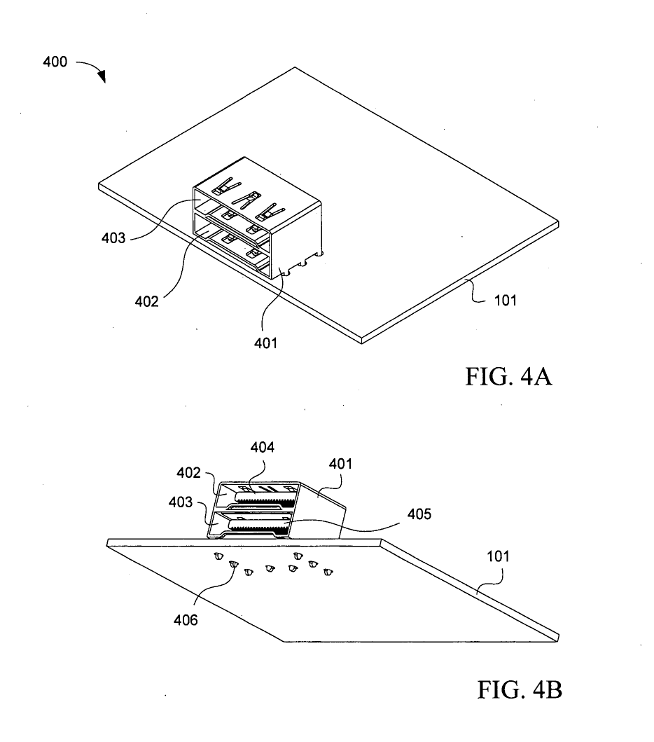

In another embodiment, two UDI connectors may be coupled together to support the dual-monitor usage model or other applications. FIG. 4 illustrates such a double-stacked UDI connector. The two UDI receptacles may be molded in the same connector housing, or plastic body and the connector shell encloses both connectors as an integrated piece.

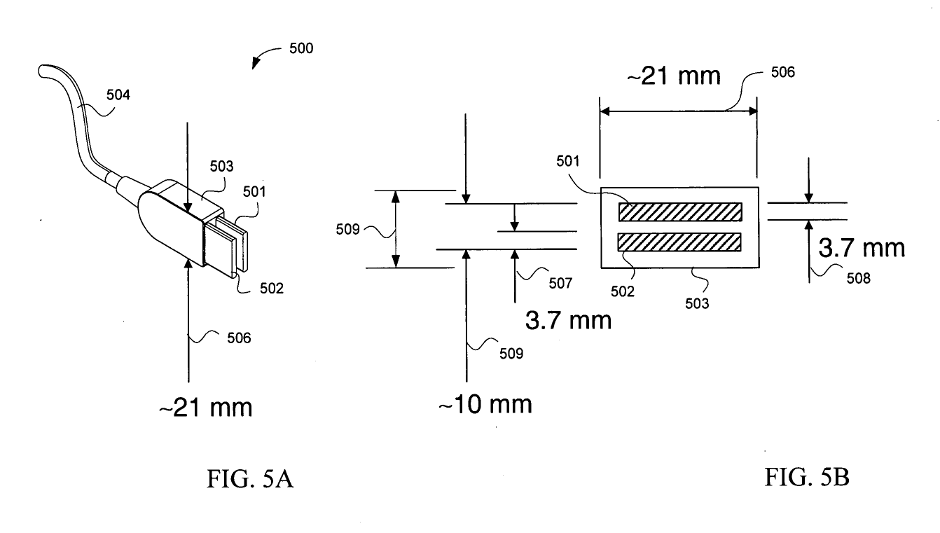

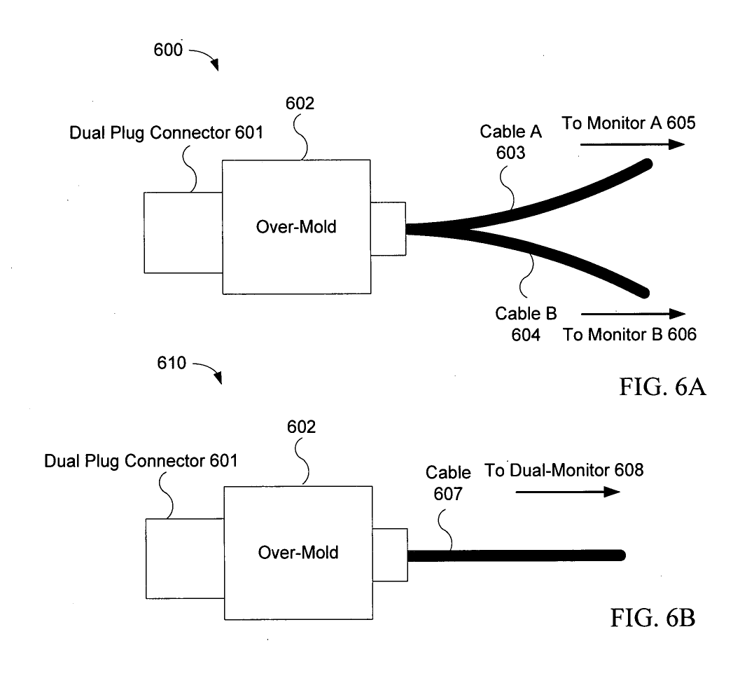

In another embodiment, one or two individual UDI cable assemblies may be plugged into such a stacked UDI receptacle connector. For use in mobile and add-in card applications, minimizing the connector height for both the receptacle and plug connectors is very important. Described herein is a method and apparatus, which includes, over-molding two UDI plug connectors together for the dual-monitor application (see FIG. 5A). The cable exiting the dual-plug over-molding may be separated into two individual UDI cables, plugging into two separate monitors (see FIG. 6A). Alternatively, both ends of a cable may have the dual-plugs molded together (see FIG. 6B). Such a dual-plug on both ends of the cable may provide double UDI lanes to support a single monitor with very high bandwidth.

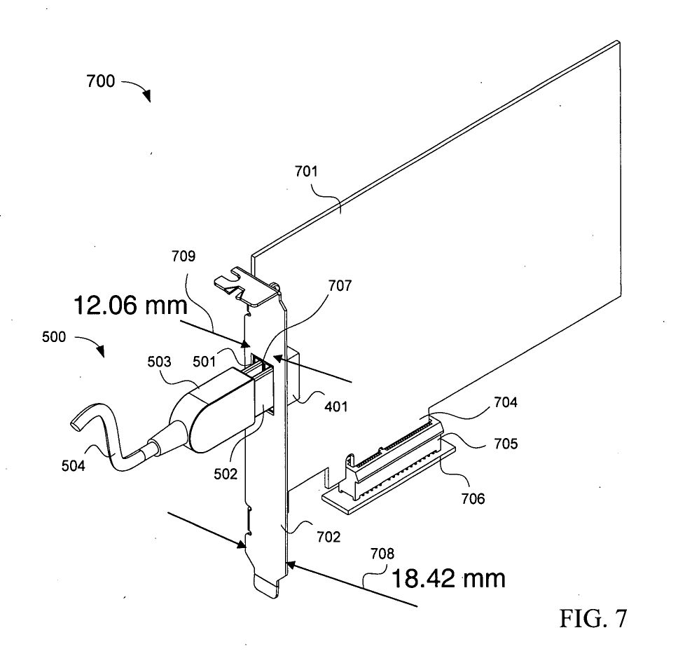

Such a dual-plug design enables the placement of two UDI plug connectors closely to each other to minimize the connector height. In one embodiment, two UDI connectors may be placed on an add-in card or on the side or back of a notebook. Alternatively, two or more UDI connectors may be placed on the motherboard I/O back-panel of a desktop computer. FIG. 7 illustrates the application of such a dual-plug-double-stacked design for an add-in card application.

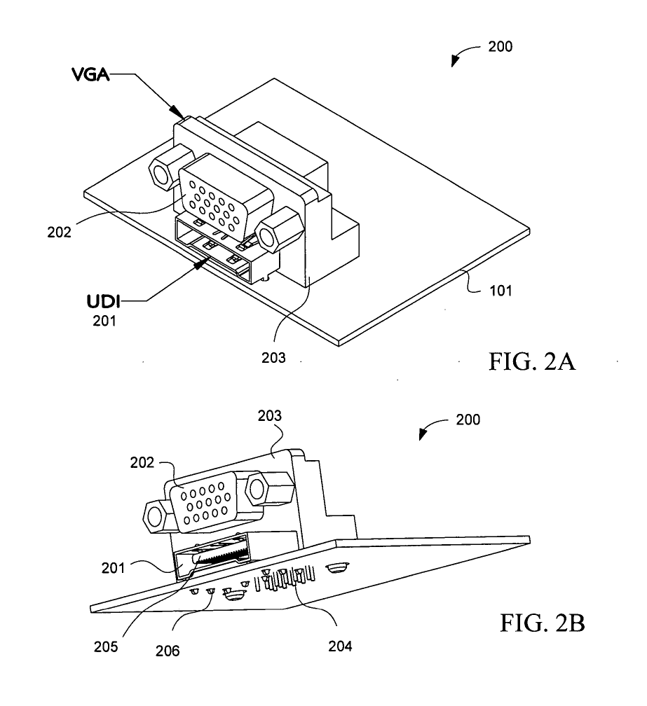

FIGS. 2A and 2B illustrate a top-side view and bottom-side view of one embodiment of stacked VGA-UDI receptacle connectors on a circuit board. Stacked connector assembly 200 includes a VGA receptacle connector 202, a UDI receptacle connector 201, and circuit board 101. VGA receptacle connector 202 and a UDI receptacle connector 201 reside in a connector assembly 203. Connector assembly 203 is coupled to a circuit board 101. Connector assembly 203 may be a molding, fitting, or over-mold. Circuit board 101 may be a motherboard or an add-in card (as described in detail below). VGA receptacle connector 202 may include a first connector housing, and the UDI receptacle connector 201 may include a second connector housing. Alternatively, VGA and UDI receptacle connectors 202 and 201 may reside in a similar housing 203, as illustrated in FIGS. 2A and 2B. Housing 203 may be an assembly, which resembles a conventional housing for VGA receptacle connectors, but includes an additional aperture or opening for housing the UDI receptacle connector 201 or the housing of the UDI receptacle connector 201. Housing 203 may be coupled to the circuit board 101. The details regarding how the housing 203 is coupled to the circuit board 101 are known in the art, and accordingly, have not been included so as to not obscure the present embodiments.

VGA receptacle connector 202 includes contact elements, which are internal to the VGA receptacle connector 202. The contact elements may be coupled to the contact elements (e.g., circuit traces) of the circuit board. VGA receptacle connector 202 may also include guideposts or positioning posts 204 that are placed through holes in the circuit board 101. The holes of the circuit board may be used to correctly position the receptacle connectors or connector assembly on the circuit board 101. Alternatively, the contact elements and positioning posts 204 may be connected to the circuit board 101 using other configurations known by those of ordinary skill in the art.

UDI receptacle connector 201 includes contact elements 205. The contact elements 205 may be coupled to the contact elements (e.g., circuit traces) of the circuit board. UDI receptacle connector 201 may also include guideposts or positioning posts 206 for mounting purposes. For example, the positioning posts 206 may be placed through holes in the circuit board. The holes of the circuit board may be used to correctly position the receptacle connectors or connector assembly on the circuit board 101. Alternatively, the contact elements 205 and positioning posts 206 may be connected to the circuit board 101 using other configurations known by those of ordinary skill in the art.

It should be noted that in FIGS. 2A and 2B the VGA receptacle connector 202 is stacked on top of the UDI receptacle connector 201 in connector assembly 203. Alternatively, the UDI receptacle connector 201 may be stacked on top of the VGA receptacle connector 202. Benefit to stacking the VGA receptacle connector 202 (or other receptacle connector types) on top of the UDI receptacle connector 201 may include increasing signal integrity by shortening propagation paths from the connector 201 to the circuit board 101, occupying no more circuit board real estate than would already be taken up by the other receptacle connector, while increasing the availability of I/O resources to the circuit board, achieving the required functionality and connector density of the circuit board, while maintaining the width and height requirements of existing circuit boards of motherboards and add-in card applications. It should also be noted that the embodiments described herein including the operation of stacking are not limited to stacking, and may include coupling the connectors in such a way that one connector is coupled between the other connector and the circuit board, regardless of the placement of the circuit board.

It should also be noted that the UDI receptacle connector may be molded in the same connector body as the VGA. The metal shell for EMI containment may be integrated together for such a connector. The UDI connector may be placed at the bottom of the stacked connector (e.g., between the VGA receptacle connector and the circuit board) to minimize the contact electrical length, optimizing the high-speed performance of the UDI connector.

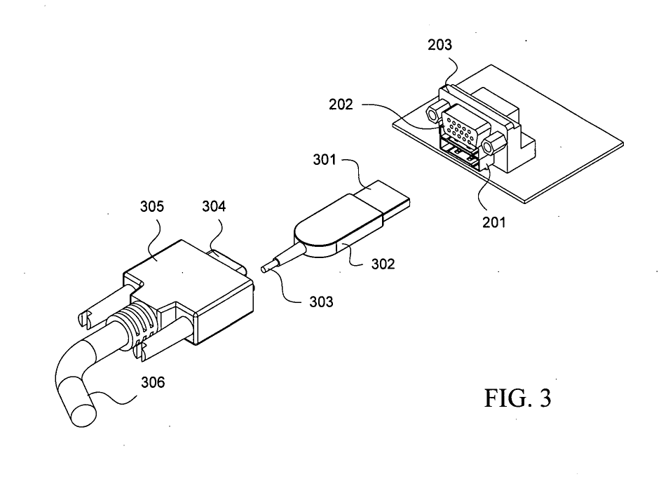

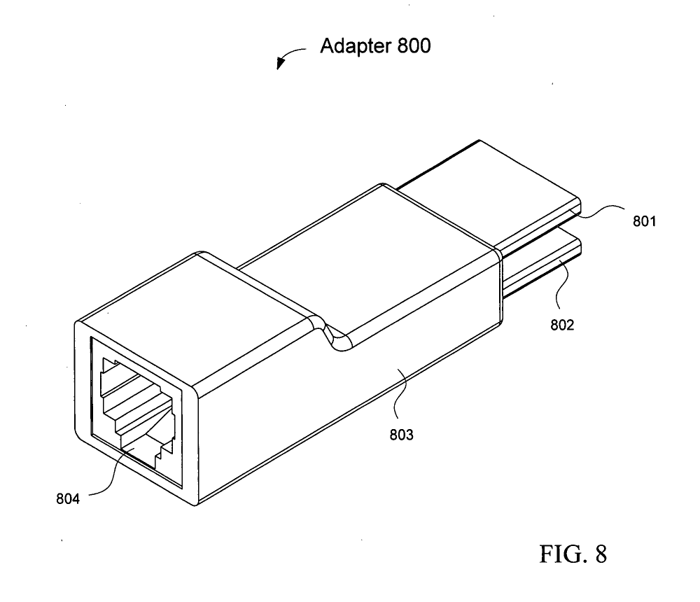

FIG. 3 illustrates a top-side view of the embodiment of FIG. 2A and a VGA cable and a UDI cable. Stacked connector assembly 200, including VGA receptacle connector 202 and UDI receptacle connector 201, as describe with respect to FIGS. 2A and 2B, is configured to receive corresponding plug connectors, VGA plug connector 304 and UDI plug connector 301. UDI plug connector 301 is configured to engage in the UDI receptacle connector 201 of the stacked connector assembly 200. UDI plug connector 301 may reside in a plug assembly 302, which may be coupled to a cable 303, or alternatively, may include an additional receptacle connector, so as to function as an adapter. The embodiments regarding the additional receptacle connector of an adapter is described below with respect to FIG. 8. At the other end of cable 303, there may be an additional UDI plug connector similar to UDI plug connector 301, or alternatively, another type of plug connector. The other UDI plug connector, at the other end of the cable 303, may be coupled to a monitor or DTV. In another embodiment, the other end of the cable 303 may be coupled directly to the monitor or DTV without the use of an additional connector.

VGA plug connector 304 is configured to engage in the VGA receptacle connector 202 of the stacked connector assembly 200. VGA plug connector 304 may reside in a plug assembly 305, which may be coupled to a cable 306. At the other end of cable 306, there may be an additional VGA plug connector 304. The other VGA plug connector 304, at the other end of the cable 303, may be coupled to a monitor. Alternatively, the cable 306 may be coupled directly to the monitor without the use of an additional connector. Plug connectors 301 and 304 may reside in separate plug assemblies 302 and 305, respectively, or alternatively, in one single plug assembly. The single plug assembly may be coupled to one cable, which is coupled to a single monitor, a dual-monitor, or a DTV; or to two cables that connect to two separate monitors, a dual-monitor, or a DTV.

FIGS. 4A and 4B illustrate a top-side view and bottom-side view of one embodiment of stacked UDI-UDI receptacle connectors. Stacked connector assembly 400 includes a housing (e.g., connector assembly), defining two apertures, or receiving chambers, coupled to circuit board 101. The first aperture or receiving chamber retains first contact elements 404 of a first UDI receptacle connector 403. The second aperture or receiving chamber retains second contact elements 405 of a second UDI receptacle connector 402. UDI receptacle connectors 402 and 403 reside in a connector assembly 401. UDI receptacle connectors 402 and 403, alternatively, may include separate housings that are coupled together. Connector assembly 401 is coupled to a circuit board 101. Circuit board 101 may be a motherboard or an add-in card (as described in detail below). The details regarding how the connector assembly 401 is coupled to the circuit board 101 are known in the art, and accordingly, have not been included so as to not obscure the present embodiments.

Connector assembly 401 may include guideposts or positioning posts, which may be positioned in holes of the circuit board 101 for properly positioning the stacked connector assembly 400 on the circuit board 101. The contact elements 404 and 405 may be coupled to the contact elements (e.g., circuit traces) of the circuit board 101. Alternatively, the contact elements 404 and 405 may be connected to the circuit board 101 using other configurations known by those of ordinary skill in the art.

It should be noted that in FIGS. 4A and 4B the UDI receptacle connectors 402 and 403 are stacked on top of each other in the stacked connector assembly 401; however, additional connectors may be stacked on top of the stacked connector assembly 401 or the second UDI receptacle connector 402. In one embodiment, an additional UDI receptacle connector may be stacked on top of the second UDI receptacle connector 402. In another embodiment, an additional receptacle connector may be stacked on to of the second receptacle connector 402. The additional receptacle connector may be of various types, for example, VGA, DVI, HDMI, USB, i.Link™ or FireWire™, RJ-45, S-Video. It should be noted that stacking additional connectors on top of the two UDI receptacle connectors may be limited by the height of the add-in card bracket (as illustrated in FIG. 7) or the height of the I/O back-panel of the chassis of the motherboard.

In one exemplary embodiment, the two stacked UDI connectors (in both the plug and receptacle) are used to support a dual-monitor usage model. Alternatively, the two stacked UDI connectors may be used in other applications, such as a single monitor, which needs double the UDI lanes to increase the bandwidth.

In another embodiment, the two UDI receptacle connectors are molded in the same connector housing, or plastic body and the connector shell encloses both connectors as an integrated piece. In one exemplary embodiment, the total height of the double-stacked UDI connectors is approximately 12 mm.

Benefit to stacking the two or more UDI receptacle connectors (e.g., 402 and 403 or other receptacle connector types) on top of each other may include increasing signal speed and integrity by occupying no more circuit board real estate than would already be taken up by the other receptacle connector(s), while increasing the availability of I/O resources to the circuit board 101, achieving the required functionality and connector density of the circuit board 101, while maintaining the width and height requirements of existing circuit boards of motherboard and add-in card applications.

FIGS. 5A and 5B illustrates a side view and a front-side view of one embodiment of a dual UDI plug connector and cable. Stacked connector assembly 400, including UDI receptacle connectors 402 and 403, as describe with respect to FIGS. 4A and 4B, is configured to receive corresponding plug connectors. FIG. 5A illustrate one embodiment of a dual plug connector 500. Dual plug connector 500 includes a first and second UDI plug connectors 501 and 502. UDI plug connectors are configured to engage in the UDI receptacle connectors 402 and 403 of the stacked connector assembly 400. UDI plug connectors 501 and 502 may reside in a plug assembly 503, which may be coupled to a cable 504, or alternatively, may include an additional receptacle connector, so as to function as an adapter. The embodiments regarding the additional receptacle connector of an adapter is described below with respect to FIG. 8. At the other end of cable 504 there may be an additional UDI plug connectors similar to UDI plug connectors 501 and 502, or alternatively, another type of plug connector. The other UDI plug connectors, at the other end of the cable 504, may be coupled to a monitor or DTV. In another embodiment, the other end of the cable 504 may be coupled directly to the monitor or DTV without the use of an additional connector.

In another embodiment, the plug assembly 503 may include additional plug connectors in addition to the UDI plug connectors 501 and 502. For example, the plug assembly 503 may include two UDI plug connectors, and a VGA plug connector, as described with respect to VGA plug connector 305. In another embodiment, the plug assembly 503 may include one UDI plug connector, and a USB plug connector. This may be used in an application, which receives video or graphics streams on the UDI lane, and receives data streams on the USB lane. Alternatively, the plug assembly 503 may include two UDI plug connectors, and one USB plug connectors.

In one embodiment, the dual plug connector, including the plug assembly 503 and two UDI plug connectors 501 and 502 may have the following dimensions: a plug assembly height 510 of greater than approximately 10 millimeters (mm); a plug assembly width 506 of approximately 21 mm; a first plug connector height 507 of approximately 3.7 mm; a second plug connector height 508 of approximately 3.7 mm; and a dual plug connector height 509 of approximately 10 mm. It should be noted that other heights may be used; however, the height of the add-in card bracket (as described with respect to FIG. 7) of conventional add-in cards is approximately 18.42 mm. Thus, the plug assembly height 510, ideally, should not be larger than 18.42, so as to stay within the add-in card bracket I/O opening and to avoid interference with other add-in cards, or other items on a computer system in which the add-in card is placed. Similarly, the connector height may be limited by the size of the opening in a notebook computer, and even the height of the body of the notebook computer. Even in an I/O back-panel of a motherboard of a desktop computer may be limited by the other components of the back-panel, such as power receptacle connectors, other ports, other add-in cards, and the like.

FIG. 6A illustrates one embodiment of a dual plug connector having two cables to couple to two monitors. Dual plug assembly 600 includes a dual plug connector 601, over-mold assembly 602, cable A 603, and cable B 604. Dual plug connector 601 may include UDI plug connectors 501 and 502, or alternatively, one UDI plug connector 501 and another plug connector of a different type (e.g., USB). Dual plug connector 601 is coupled to over-mold assembly 602. Over-mold assembly 602, in one embodiment, may be an over-molding that houses the multiple plug connectors, for example, two UDI plug connectors, one UDI connector and one USB plug connector, or even two UDI plug connectors and a USB connector. The multiple plug connectors of over-mold assembly 602 are coupled to one cables A 603 and cable B 604. Cable A 603 may be coupled to a first monitor, monitor A 605, or alternatively, to a DTV. Cable B 604 may be coupled to a second monitor, monitor B 606, or alternatively, to a second DTV.

In one embodiment, molding two plug connectors on the same cable over-mold may be used to achieve a minimum z-height. This is particularly important, when dealing with a limited height on an add-in card bracket and mobile systems that are sensitive to height and real estate restrictions. In one embodiment, the over-mold may be coupled to one cable that couples to a single monitor or DTV with double UDI lanes for higher bandwidth. In another embodiment, the over-mold may be coupled to two individual cables with corresponding plug connectors at the other end that connect to two different monitors or DTVs).

FIG. 6B illustrates one embodiment of a dual plug connector having one cable to couple to a double-lane-width single monitor. Dual plug assembly 610 includes all the same components as dual plug assembly 600, except that instead of having two cables, cables A and B 603 and 604, the multiple plug connectors of over-mold assembly 602 are coupled to one cable, cable 607. Cable 607 may be coupled to a single monitor 608 with double UDI lanes, or alternatively, to a DTV.

FIG. 7 illustrates one embodiment of a bracket of an add-in card, including stacked UDI-UDI receptacle connectors. Stacked connector assembly 700 includes an add-in card circuit board 701, an add-in card bracket 702, and connector assembly 401, which includes two UDI receptacle connectors 402 and 403. Stacked connector assembly 700 may also include, as part of the add-in card circuit board 701, an add-in card connector portion 704. Add-in card connector portion 704 is used to couple the add-in card circuit board 701, both functionally and structurally, with circuit board 706 (e.g., motherboard), via bridge 705. It should be noted that only a portion of the circuit board 706 has been illustrated in FIG. 7. Bridge 705 operates to functionally and structurally connect the add-in card 701 to the circuit board 706. Details regarding the connection of add-in card 701 to circuit board 706, are known by those of ordinary skill in the art, and accordingly, have not been included so as to not obscure the present embodiments.

Bracket 702 may be a conventional bracket for add-in cards. The height 708 of the add-in card bracket 702 may be approximately 18.42 mm. It should be noted that the height of the brackets may differ without departing from the scope of the present embodiments. Bracket 702 may include an opening 707, in which, plug connectors may be connected to receptacle connectors mounted on the bracket 702 or add-in card circuit board 701. In one embodiment, the opening 707 may have a height 709 of 12.06 mm. Alternatively, the opening 707 may have different heights; however, it should be noted that the height 709 of the opening 707 may be limited by the height 708 of the bracket 702. For example, the height of the opening 707 may need to be smaller than the total height 708 (e.g., 18.42) of the bracket 707. Assuming a fixed height for all add-in cards as used in the industry, the stacking of receptacle connectors for an add-in card is limited to having an opening 707 of height 709 that is less than the fixed height of the bracket. Similarly, a fixed height may be assumed for motherboard I/O back-panels, and correspondingly, the height of the stacked connectors is limited to have an opening that is less than the fixed height of the I/O back-panel.

FIG. 7 also illustrates the dual plug connector 500, including a first and second UDI plug connectors 501 and 502, which reside in a single plug assembly 503, as described with respect to FIGS. 5A and 5B. UDI plug connectors 501 and 502 are configured to engage in the UDI receptacle connectors of the connector assembly 401. Plug assembly 503, which may be coupled to a cable 504 (as illustrated in FIG. 7), or alternatively, may include an additional receptacle connector, so as to function as an adapter. The embodiments regarding the additional receptacle connector of an adapter is described below with respect to FIG. 8. As previously mentioned, the other end of cable 504 there may be an additional UDI plug connectors similar to UDI plug connectors 501 and 502, or alternatively, another type of plug connector. The other UDI plug connectors, at the other end of the cable 504, may be coupled to a monitor or DTV. In another embodiment, the other end of the cable 504 may be coupled directly to the monitor or DTV without the use of an additional connector. In one exemplary embodiment, the add-in card 701 may be a graphics card.

FIG. 8 illustrates one embodiment of an adapter having dual UDI plug connectors at one end and a receptacle connector at the other. Adapter 800 includes a first UDI plug connector 801 and a second UDI plug connector 802 at a first end. First and second UDI plug connectors 801 and 802 may reside in an over-mold, or connector assembly 803. Connector assembly 803, at the second end, includes a receptacle connector 804. In one exemplary embodiment, the receptacle connector 804 is a HDMI receptacle connector. In another exemplary embodiment, the receptacle connector 804 is a DVI receptacle connector. Alternatively, the receptacle connector 804 may be of one of the following types of receptacle connectors, VGA, i.Link™ or FireWire™, S-Video, or one or more other receptacle connectors known by those of ordinary skill in the art.

Adapter 800 may be used to increase the capability of a personal computer that includes a dual UDI receptacle connector by allowing other types of plug connectors to connect to the personal computer, without having that specific type of receptacle connector for the other types of plug connectors. For example, two stacked UDI receptacle connectors occupy less real estate than a VGA receptacle connector, but increase the functionality and bandwidth. However, because VGA is a commonly used connector for monitors, using the adapter 800 may increase the robustness of a personal computer (e.g., using UDI or VGA using only UDI receptacle connector(s)) while decreasing the occupied real estate on the motherboard I/O back-panel or add-in card of the personal computer. As previously mentioned, a VGA receptacle connector may be stacked on a UDI receptacle connector to achieve similar robustness as the adapter 800 (e.g., providing UDI or VGA capability) for the personal computer.

In one embodiment, the apparatus for coupling a UDI connector to another connector on a motherboard or an add-in card includes a first UDI receptacle connector including a first connector housing, and second UDI receptacle connector including a second connector housing. The first connector housing is coupled to the circuit board, which may be a motherboard or an add-in card (e.g., graphics card). The second connector housing is mounted or coupled to the first connector housing. It should be noted that although described as having separate connector housings, the two receptacle connectors may reside in a single connector housing or connector assembly. The second receptacle connector may be another UDI receptacle connector, or alternatively, a VGA, USB, DVI, HDMI, S-Video, RJ-45, or i.Link™ or FireWire™ receptacle connectors. In another embodiment, one or more receptacle connectors may be coupled to the UDI receptacle connector.

In one embodiment, the apparatus for molding multiple plug connectors includes a first UDI cable having UDI plug connectors at each end of the first UDI cable, and a second cable having plug connectors at each end of the second cable. One of the UDI plug connectors of the first UDI cable is connected to the first UDI receptacle, and one of the plug connectors of the second cable is connected to the second receptacle connector. One of the UDI plug connectors and one of the second plug connectors are molded in a single connector assembly. One cable may be coupled to either a monitor, DTV, or other display device, and the other cable may be coupled to another peripheral device, such as another monitor, a TV, DTV, a PDA, a multi-media handheld, a digital camera, a digital camcorder, a DVD player, a DVR, or a VCR. In another embodiment, the two cables may be two UDI cables, having two UDI plug connectors on each end of the cable. At least at one end of the two UDI cables, two UDI plug connectors may be stacked and molded in one connector assembly. The stacked UDI plugs may connect to the stacked UDI receptacle connectors of a computer. The other end of the two UDI cables may also include two stacked UDI plug connectors that connect to a single, double-lane-width monitor, or other peripherals.

In another embodiment, the apparatus may include a first UDI plug connector to be operatively coupled to the first UDI receptacle connector, a second plug connector to be operatively coupled to the second receptacle connector, and an additional receptacle connector to receive an additional plug connector. For example, the additional receptacle connecter may be of a connector type of DVI, or HDMI. Alternatively, other high-speed display interface types known by those of ordinary skill in the art may be used.

In one embodiment, the method for coupling a UDI connector with another connector on a motherboard or add-in card includes mounting a first UDI receptacle connector on a circuit board, in first operation, and coupling a second receptacle connector to the first UDI receptacle connector, such that the first UDI receptacle connector is coupled between the second receptacle connector and the circuit board, in a second operation. In one exemplary embodiment, the second receptacle connector is mounted or stacked above the first UDI connector, which is mounted to a horizontally positioned circuit board. In another exemplary embodiment, the second receptacle connector is mounted or stacked to the side of the first UDI connector, which is mounted to a vertically positioned circuit board. Alternatively, the method may include mounting the second receptacle connector on the circuit board, in the first operation, and coupling a first UDI receptacle connector to the other receptacle connector such that the second receptacle connector is coupled between the first UDI connector and the circuit board, in a second operation. The method may further include coupling one or more additional connectors to the second receptacle connector. The second receptacle connector may be another UDI receptacle connector, or alternatively, a USB, a VGA, an i.Link™ or FireWire™, a RJ-45, a DVI, a HDMI, or an S-Video receptacle connector. The circuit board may be a motherboard, or alternatively, an add-in card. The add-in card may include a bracket that includes an opening for the receptacle connectors to receive the corresponding plug connectors. The method may further include providing a first UDI plug connector to be connected to the first UDI receptacle connector, or alternatively, providing a first UDI plug connector to be connected to the first UDI receptacle connector and providing a second UDI plug connector to be connected to the second UDI receptacle connector, wherein the first and second UDI plug connector are housed within a single connector assembly. In another embodiment, the method may include providing a plug assembly (e.g., fitting or cable molding or over-mold) including a first and second UDI plug connector, the first UDI plug connector to be connected to the first UDI receptacle connector, and the second UDI receptacle connector to be connected to the second UDI receptacle connector.

In one embodiment, the method for molding multiple plug connectors includes providing a first UDI plug connector, providing a second I/O plug connector, and molding the first UDI plug connector and the second I/O plug connector into a plug assembly. The second I/O plug connector may be a VGA plug connector, another UDI plug connector (e.g., dual UDI plug connector). Alternatively, the second I/O plug connector may be a USB, a VGA, an i.Link™ or FireWire™, an RJ-45, a DVI, a HDMI, or an S-Video receptacle connector. One or more cables may be connected to the plug assembly. The one or more cables may include one or more plug assemblies on the other end of the cable to connect to other electronic peripheral devices, for example, TV, DTV, a PDA, multi-media handhelds, digital cameras, digital camcorders, DVD players, DVRs, VCRs, or consumer electronic electronics known by those of ordinary skill in the art.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A method, comprising:
mounting a first unified display interface (UDI) receptacle connector on a circuit board; and
coupling a second receptacle connector to the first UDI receptacle connector, such that the first UDI receptacle connector is coupled between the second receptacle connector and the circuit board.

2. The method of claim 1, wherein the circuit board is a motherboard.

3. The method of claim 1, wherein the circuit board is an add-in card.

4. The method of claim 1, wherein the second receptacle connector is a second UDI receptacle connector.

5. The method of claim 1, wherein the second receptacle connector is at least one of a universal serial bus (USB), a video graphics array (VGA), an IEEE 1394, a registered jack-45 (RJ-45), a digital visual interface (DVI), a high-definition multi-media interface (HDMI), or a super-video (S-Video) receptacle connector.

6. The method of claim 1, further comprising providing a first UDI plug connector to be connected to the first UDI receptacle connector.

7. The method of claim 2, further comprising:
providing a first UDI plug connector to be connected to the first UDI receptacle connector; and
providing a second UDI plug connector to be connected to the second UDI receptacle connector, wherein the first and second UDI plug connector are housed within a single connector assembly.

8. A method, comprising:
providing a first unified display interface (UDI) plug connector;
providing a second input-output (I/O) plug connector; and
molding the first UDI plug connector and the second I/O plug connector into a plug assembly.

9. The method of claim 8, wherein the second I/O plug connector is a visual graphics array (VGA) plug connector.

10. The method of claim 8, wherein the second I/O plug connector is a second UDI plug connector.

11. The method of claim 8, wherein the second I/O plug connector is a universal serial bus (USB), an IEEE 1394, a registered jack-45 (RJ-45), a digital visual interface (DVI), a high-definition multi-media interface (HDMI), or a super-video (S-Video) plug connector.

12. The method of claim 8, further comprising connecting one or more cables to the plug assembly.

13. An apparatus, comprising:
a first unified display interface (UDI) receptacle connector including a first connector housing, the first connector housing of the first UDI receptacle connector to be mounted to a circuit board; and
a second receptacle connector including a second connector housing, the second connector housing of the second receptacle connector to be mounted to the first connector housing of the UDI receptacle connector, wherein the first UDI receptacle connector is between the second receptacle connector and the circuit board.

14. The apparatus of claim 13, wherein the circuit board is at least one of a motherboard or an add-in card.

15. The apparatus of claim 13, wherein the first connector housing of the first UDI receptacle connector and the second connector housing of the second receptacle connector are molded in a connector assembly.

16. The apparatus of claim 13, wherein the second receptacle connector is a second UDI receptacle connector.

17. The apparatus of claim 13, wherein the second receptacle connector is a video graphics array (VGA) receptacle connector.

18. The apparatus of claim 13, wherein the second receptacle connector is at least one of a universal serial bus (USB), a video graphics array (VGA), an IEEE 1394, a registered jack-45 (RJ-45), a digital visual interface (DVI), a high-definition multi-media interface (HDMI), or a super-video (S-Video) receptacle connector.

19. The apparatus of claim 13, further comprising:
a first UDI cable having UDI plug connectors at each end of the first UDI cable, wherein a first UDI plug connector of the first UDI cable is to be operatively coupled to the first UDI receptacle connector; and
a second cable having plug connectors at each end of the second cable, wherein a first plug connector at the first end of the second cable is to be operatively coupled to the second receptacle connector, wherein the first UDI plug connector and the second plug connector reside in a single plug assembly.

20. The apparatus of claim 19, wherein a second UDI plug connector of the first UDI cable is coupled to at least one of a monitor or a digital television (DTV), and wherein a second plug connector at the second end of the second cable is coupled to a peripheral device.

21. The apparatus of claim 20, wherein the peripheral device is at least one of a monitor, a TV, DTV, a personal data assistant (PDA), a multi-media handheld, a digital camera, a digital camcorder, a DVD player, a digital video recorder (DVR), a video cassette recorder (VCR).

22. The apparatus of claim 19, wherein the second receptacle connector is a second UDI receptacle connector and the second plug connector is a second UDI plug connector, wherein the second cable is a second UDI cable, and wherein the first UDI cable is coupled to a first monitor and the second UDI cable is coupled to a second monitor.

23. The apparatus of claim 13, further comprising:
a UDI cable having two UDI plug connectors at a first end of the UDI cable, wherein a first UDI plug connector of the UDI cable is to be operatively coupled to the first UDI receptacle connector, wherein a second UDI plug connector of the UDI cable is to be operatively coupled to the second receptacle connector, wherein the second receptacle connector is a UDI receptacle connector coupled to the first UDI receptacle connector, and wherein a second end of the UDI cable is coupled to a dual-monitor.

24. The apparatus of claim 13, further comprising:
an adapter comprising a plug assembly comprising:
a first UDI plug connector to be operatively coupled to the first UDI receptacle connector;
a second plug connector to be operatively coupled to the second receptacle connector; and
an additional receptacle connector to receive an additional plug connector.

25. The apparatus of claim 24, wherein the additional receptacle connector and additional plug connector is of a connector type of at least one of digital visual interface (DVI), or high-definition multi-media interface (HDMI).

26. An apparatus, comprising:
a first unified display interface (UDI) receptacle connector including a first connector housing;
means for coupling a second receptacle connector to the first connector housing of the first UDI receptacle connector.

27. The apparatus of claim 26, further comprising means for mounting the first UDI receptacle connector to an add-in card, wherein the first UDI receptacle connector is coupled between the second receptacle connector and the add-in card.

28. The apparatus of claim 26, further comprising means for mounting the first UDI receptacle connector to a motherboard, wherein the first UDI receptacle connector is coupled between the second receptacle connector and the motherboard.

29. The apparatus of claim 26, wherein means for coupling the second receptacle connector comprises coupling a second UDI receptacle connector to the first connector housing of the first UDI receptacle connector.

30. The apparatus of claim 26, wherein the second receptacle connector is at least one of a universal serial bus (USB), a video graphics array (VGA), IEEE 1394, registered jack-45 (RJ-45), digital visual interface (DVI), high-definition multi-media interface (HDMI), or super-video (S-Video) receptacle connector.
